(19) United States
(12) Patent Application Publication
(10) Pub. No.: US 2025/0316716 A1
(43) Pub. Date: Oct. 9, 2025

(54) ELECTROCHEMICAL OXYGEN REDUCTION CATALYST

(71) Applicant: TOYOTA JIDOSHA KABUSHIKI KAISHA, Toyota-shi (JP)

(72) Inventor: Keiichi OKUBO, Susono-shi (JP)

(73) Assignee: TOYOTA JIDOSHA KABUSHIKI KAISHA, Toyota-shi (JP)

(21) Appl. No.: 19/004,966

(22) Filed: Dec. 30, 2024

(30) Foreign Application Priority Data
Apr. 8, 2024 (JP) 2024-061901

(51) Int. Cl. H01M 4/90; H01M 12/04; H01M 12/08

(52) U.S. Cl. CPC H01M 4/9008; H01M 4/9083; H01M 12/04; H01M 12/08

(57) ABSTRACT

The present disclosure relates to an electrochemical oxygen reduction catalyst comprising metal particles and a modifier for modifying the metal particles, wherein the modifier is an organic nitrogen compound, wherein the organic nitrogen compound comprises pyridine type nitrogen and may further comprise a quaternary nitrogen, and wherein the organic nitrogen compound has a total content of the pyridine type nitrogen and, if present, the quaternary nitrogen of 40 g/eq or less.

### CROSS-REFERENCE TO RELATED APPLICATION

This application claims priority to Japanese Patent Application No. 2024-061901 filed on Apr. 8, 2024, incorporated herein by reference in its entirety.

### BACKGROUND

### 1. Technical Field

The present disclosure relates to an electrochemical oxygen reduction catalyst.

### 2. Description of Related Art

Electrochemical oxygen reduction catalysts are widely used in fuel cells, metal-air electrochemical cells, and so forth. As an electrochemical oxygen reduction catalyst, a catalyst in which a surface of platinum is modified by a melamine compound is known (WO 2019/221156, WO 2021/090746).

However, the melamine compound is hydrophilic, and accordingly when a catalyst of which the melamine compound is a modifier is used, water that is created is retained in a catalyst layer. The water retained in the catalyst layer then becomes an oxygen source and oxidizes a catalyst carrier such as carbon or the like, and thus the performance of the fuel cell or the like is made to deteriorate.

### SUMMARY

As described above, in conventional electrochemical oxygen reduction catalysts, performance of fuel cells or the like may deteriorate due to oxidation. Accordingly, an object of the present disclosure is to provide an electrochemical oxygen reduction catalyst having improved oxidation resistance.

The present inventors have found that oxidation resistance of an electrochemical oxygen reduction catalyst is improved by using an organic nitrogen compound in which content of pyridine type nitrogen and quaternary nitrogen is controlled to be within a specific range, as a modifier, and thus have completed the present disclosure.

That is to say, the gist of the present disclosure is as follows.

### Form 1

An electrochemical oxygen reduction catalyst, including
metal particles, and a modifier that modifies the metal particles, in which
the modifier is an organic nitrogen compound, and
the organic nitrogen compound contains pyridine type nitrogen and may further contain quaternary nitrogen, in which total content in the organic nitrogen compound of the pyridine-type nitrogen and, when present, the quaternary nitrogen, is 40 g/eq or less.

### Form 2

The electrochemical oxygen reduction catalyst according to Form 1, in which the modifier is a deammoniated condensate of melamine.

### Form 3

The electrochemical oxygen reduction catalyst according to Form 2, in which the deammoniated condensate of melamine is at least one selected from a group consisting of melem, melam, melone, and g-C₃N₄.

### Form 4

The electrochemical oxygen reduction catalyst according to any one of Forms 1 to 3, in which the metal particles are at least one selected from a group consisting of platinum particles, platinum alloy particles, and composite particles containing platinum.

### Form 5

The electrochemical oxygen reduction catalyst according to any one of Forms 1 to 4, in which the metal particles are supported by a carrier, and the carrier is carbon.

According to the present disclosure, an electrochemical oxygen reduction catalyst with improved oxidation resistance can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing cell voltages after a durability test in 3.2 Acm⁻² for Examples 1 and 2 and Comparative Examples 1 and 2; and

FIG. 2 is a graph showing the voltage retention after a durability test in 3.2 Acm⁻² for Examples 1 and 2 and Comparative Examples 1 and 2.

### DETAILED DESCRIPTION OF EMBODIMENTS

Hereinafter, preferred embodiments of the present disclosure will be described in detail.

The electrochemical oxygen reduction catalyst of the present disclosure (hereinafter also referred to as the catalyst of the present disclosure) includes metal particles and a modifier that modifies the metal particles.

The metal constituting the metal particles may be any metal having oxygen reduction activity (oxygen reduction catalytic ability). Examples of the metal constituting the metal particles include metals such as platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and two or more of these metals may be used. The metal may be an oxide, a nitride, a sulfide, a phosphide, or the like. In one embodiment, the metal particles are at least one selected from the group consisting of platinum particles, platinum alloy particles, and composite particles comprising platinum. Examples of the metal other than platinum contained in the platinum alloy and the composite particles containing platinum include the metals (excluding platinum) described above for the metals constituting the metal particles, and two or more of these metals may be included. The elemental ratio of metals other than platinum in the platinum alloy is not particularly limited, and may be from 0.11 atm % to 60 atm %. The particle size of the metallic particles is not particularly limited, and may be 1 nm to 100 nm. In the present disclosure, the particle size of the particles is an average crystallite size measured by an X-ray diffraction method. The particle size of the particles may be 100 to 1000 particles measured by an electron microscope, and the average value thereof may be the average particle size of the particles.

The metal particles may be supported on a carrier. In this case, the catalyst of the present disclosure includes a support, metal particles supported on the carrier, and a modifier. The method of supporting the metal particles on the carrier is not particularly limited, and a conventionally known method can be appropriately employed. The carrier may be a primary particle or a secondary particle. The particle size of the primary particles of the carrier may be, for example, from 5 nm to 5000 nm. The metal supporting ratio of the metal particles supported on the carrier is not particularly limited, and may be 1% to 70%, or 18% to 48%. The carrier may be carbon having conductivity, an oxide, or the like, or a mixture containing these. The carbon may be carbon black (such as acetylene black, Ketjen black, and furnace black), activated carbon, graphite, glassy carbon, graphite, graphene, carbon fiber, carbon nanotube, carbon nitride, sulfurized carbon, and phosphated carbon, channel black, roller black, disk black, oil furnace black, gas furnace black, lamp black, thermal black, Vulcan carbon, or a mixture containing two or more of the foregoing. The oxide may be titanium oxide, niobium oxide, tin oxide, tungsten oxide and molybdenum oxide, or a mixture containing two or more of these. In one embodiment, the metal particles are supported on a carrier and the carrier is carbon.

The modifier is an organic nitrogen compound. The organic nitrogen compound includes pyridine type nitrogen, and may further include a quaternary nitrogen. That is, the organic nitrogen compound is a compound containing a pyridine type nitrogen or a compound containing a pyridine type nitrogen and a quaternary nitrogen. The organic nitrogen compound may include a triazine ring including a pyridine type nitrogen, or a triazine ring including a pyridine type nitrogen and a quaternary nitrogen. Hereinafter, an organic nitrogen compound used as a modifier will be described.

The organic nitrogen compound has a total content (nitrogen equivalent) of pyridine type nitrogen and, if present, quaternary nitrogen of less than or equal to 40 g/eq. That is, when the organic nitrogen compound contains a pyridine type nitrogen and does not contain a quaternary nitrogen, the content of the pyridine type nitrogen is 40 g/eq or less. When the organic nitrogen compound includes pyridine type nitrogen and quaternary nitrogen, the total content of pyridine type nitrogen and quaternary nitrogen is 40 g/eq or less. When the organic nitrogen compound satisfies the nitrogen content, the hydrophobicity is improved with respect to the melamine of the prior art, and the oxidation resistance of the catalyst is improved. In addition, in the electrochemical oxygen reduction reaction, the oxygen transport property is improved, and a decrease in the voltage in the high current density region is suppressed. The total content of pyridine type nitrogen and, if present, quaternary nitrogen in the organic nitrogen compound may be less than or equal to 31.5 g/eq from the viewpoint of improving the catalytic oxidation resistance. The nitrogen equivalent can be calculated from the following equation: The smaller this value, the greater the amount of nitrogen in the compound. In the case of the polymer, the value of the constituent monomer is regarded as the value of the polymer.

Nitrogen equivalent (g/eq)=molecular weight (g/mol)/molecular weight of nitrogen material (molN/mol)

In the present disclosure, the pyridine type nitrogen refers to a nitrogen in the same bonding state as the nitrogen of pyridine. pyridine type nitrogen is bonded to two carbon atoms, one carbon atom is bonded by a single bond, and the other carbon atom is bonded by a double bond. On the other hand, quaternary nitrogen refers to a quaternary nitrogen atom bonded to three carbon atoms. In the following, pyridine type nitrogen and quaternary nitrogen are shown using the structural formula of melem. In the structure of melem, pyridine type nitrogen was surrounded by a solid line, and quaternary nitrogen was surrounded by a dotted line. The exocyclic nitrogen is not a pyridine type nitrogen or a quaternary nitrogen.

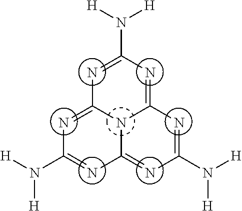 [SMILES: NC1=NC2=NC(N)=NC3=NC(N)=NC(=N1)N23]

The organic nitrogen compound may have a water solubility of less than 3 at 25° C. and may be 1.5 or less. Also, the organic nitrogen compound may have an alcohol (diacetone alcohol or ethanol) solubility of less than 3 at 25° C., and may have a solubility of 1.5 or less.

The organic nitrogen compound may have a total nitrogen equivalent of 21.5 g/eq or more. The organic nitrogen compound may have a total nitrogen weight ratio of 65 wt % or less. The organic nitrogen compound may have a ratio of the total number of nitrogen atoms in the total number of atoms in the molecule of 45% or more. The total nitrogen means all the nitrogen in the compound including pyridine type nitrogen, quaternary nitrogen, and nitrogen other than these.

The modifier may be a deammoniated condensate of melamine. The deammoniated condensate of melamine may be at least one selected from the group consisting of melem, melam, melone and g-C₃N₄ (graphitic carbon nitride). Incidentally, the combined content of pyridine type nitrogen and the quaternary nitrogen, melem is 31.1 g/eq, melam is 39.2 g/eq, melone is 31.1 g/eq, g-C₃N₄ is 23.0 g/eq. Since melam does not contain quaternary nitrogen, the value shown for melam is the content of pyridine type nitrogen.

In one embodiment, the modifier is melem and g-C₃N₄.

The modifier may be melem, melam, melone or a derivative of g-C₃N₄. In one embodiment, the modifier is a melem derivative or a polymer comprising the derivative as a monomer. In one embodiment, the melem derivative is a compound represented by the general formula (1).

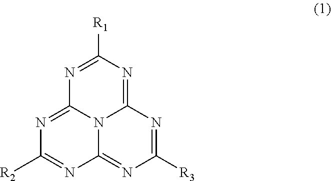

(In the formula, each of R₁, R₂, and R₃ is a hydrogen atom, a halogen atom, or one kind of functional group selected from a group of functional groups consisting of a nitrile group, an amido group, an imine group, an amino group, a thiol group, a hydroxyl group, a sulfo group, a carboxylic acid group, a phosphoric acid group, a ketone group, an aldehyde group, an ester group, an alkoxy group, a phenol group, a cyclopentyl group, a cyclohexyl group, an alkylamino group having 1 to 10 carbon atoms, an alkylsulfonic acid group having 1 to 10 carbon atoms, a perfluoroalkyl group having 1 to 10 carbon atoms, and an alkyl group having 1 to 10 carbon atoms, an alkenylamino group having 2 to 10 carbon atoms, an alkenylsulfonic acid group having 2 to 10 carbon atoms, a perfluoroalkenyl group having 2 to 10 carbon atoms, and an alkenyl group having 2 to 10 carbon atoms, the functional groups each arbitrarily have, in a molecular chain, at least one kind selected from a group consisting of at least one kind of functional group selected from the group of functional groups, an aromatic ring, a heterocyclic ring, an oxygen atom, a sulfur atom, and a nitrogen atom, and not all of the R₁, R₂, and R₃ are amine groups (—NH₂).)

The compound represented by Formula (1) has a total content of pyridine type nitrogen and quaternary nitrogen of 40 g/eq or less. Therefore, in the general formula (1), the R₁, the R₂, and the R₃ are selected so that the total content of the pyridine type nitrogen and the quaternary nitrogen of the compound represented by the general formula (1) is equal to or less than 40 g/eq.

As described above, the modifier may be a polymer containing a compound represented by the general formula (1) as a monomer. For example, in the general formula (1), when the R₁, the R₂, and the R₃ contain a polymerizable functional group, a polymer having the compound represented by the general formula (1) as a monomer can be formed. Examples of the polymerizable functional group include an addition polymerizable functional group (for example, an ethylenic double bond group included in an alkenyl group) and a condensation polymerizable functional group (for example, an amino group and a carboxylic acid group, and a hydroxyl group and a carboxylic acid group).

The modifier may be a mixture of two or more of the compounds represented by the general formula (1). The modifier may be a mixture of two or more kinds of polymers each containing a compound represented by the general formula (1) as a monomer. The modifier may be a mixture of a polymer containing a compound represented by the general formula (1) and a compound represented by the general formula (1) as monomers.

In one embodiment, the modifier is free of fluorine atoms.

The catalyst of the present disclosure can be prepared, for example, by a method such as a dissolution-drying method or a gas phase method, in which metal particles optionally supported on a carrier and a modifier are prepared.

The catalyst of the present disclosure can be used, for example, by preparing a catalyst ink containing the catalyst of the present disclosure and applying the catalyst ink to a substrate. When the catalyst ink is applied to the substrate and the solvent of the catalyst ink is removed, a catalyst layer is formed on the substrate.

The catalyst ink may include the electrochemical oxygen reduction catalyst, the ionomer, and the solvent. That is, the catalyst ink may include metal particles (which may be supported on a carrier), modifiers, ionomers, and solvents.

Ionomers are polyelectrolytes having ion exchange groups. Ion exchange groups of the ionomer are not particularly limited, and examples thereof include sulfonic acid, phosphoric acid, and quaternary ammonium cations. The ionomer may be a perfluorocarbon sulfonic acid polymer, an anion exchange polymer, or a polymer based on polyether ether ketone, polybenzimidazole, and the like.

The solvent of the catalyst ink is not particularly limited, and may be, for example, water, alcohol, or a mixed solution of water and alcohol. The alcohol is not particularly limited. Exemplary alcohols include methanol, diacetone alcohol, ethanol, 1-propanol, 2-propanol (isopropanol), tert-butyl alcohol, ethylene glycol, propylene glycol, and the like.

The catalyst ink can be prepared, for example, by charging a predetermined amount of the above-described components into a container and stirring them using a stirrer.

In forming the catalyst layer, for example, the catalyst layer is coated on a substrate such as an electrolyte membrane or a gas-diffusion layer (GDL). After the coating, the catalyst ink is heated and the solvent is dried and removed. The electrolyte membrane has, for example, polytetrafluoroethylene (PTFE) or an ion-exchange group. The gas diffusion layer is made of, for example, carbon fiber or metal fiber. The gas-diffusion layer is composed of, for example, a carbon fiber or a metallic fiber having a microporous layer (MPL). The coating thickness may be from 5 μm to 30 μm. The metal particle content may be in 0.1 mgcm⁻² to 0.6 mgcm⁻².

Since the catalyst of the present disclosure has improved oxidation resistance, deterioration in performance of a fuel cell or the like is suppressed. Therefore, the catalyst of the present disclosure can be suitably used in fuel cells, metal-air cells, and the like.

Hereinafter, the present disclosure will be described in more detail with reference to Examples. However, the technical scope of the present disclosure is not limited to these examples.

### Preparation of Catalyst Ink

Catalyst inks containing the catalyst and the ionomer in a solvent were prepared. As a modifier, melem (Example 1), g-C₃N₄ (Example 2) and melamine (Comparative Example 2) were used, respectively.

### EXAMPLES

The platinum particles were supported on a carbon carrier. A carbon carrier on which platinum particles were supported, a perfluorocarbon sulfonate polymer (EW: 1100) (Ionomer) (manufactured by Nafion (Chemours), melem (manufactured by Tokyo Chemical Industry Co., Ltd.) (modifier), and solvents composed of water and diacetone alcohol were charged into a container. These were stirred using a stirrer to prepare a catalyst ink.

### Example 2

Catalytic inks were prepared in the same manner as in Example 1, except that the modifier was changed to g-C₃N₄ (manufactured by Tokyo Chemical Industry Co., Ltd.).

### Comparative Example 1

A catalyst ink was prepared in the same manner as in Example 1 except that no modifier was used.

### Comparative Example 2

A catalyst ink was prepared in the same manner as in Example 1 except that the modifier was changed to melamine (manufactured by Fujifilm Wako Pure Chemical Industries, Ltd.).

### Preparation of Evaluation Samples

The catalyst inks were coated on polytetrafluoroethylene (PTFE), heated, and the solvents of the catalyst inks were dried and removed to form catalyst layers on PTFE.

The formed catalyst layer was prepared as a cathode catalyst layer, an electrolyte membrane (NafionNR211) was prepared, and an anode catalyst layer containing TEC10E50E (manufactured by Tanaka Kiyoshi Kogyo Co., Ltd.) was prepared as an anode catalyst. The membrane-electrode assembly was prepared by sandwiching the electrolyte membrane between the cathode catalyst layer and the anode catalyst layer and thermocompression bonding them at 130° C. and 3 MPa. Two gas diffusion layers (GDL22BB manufactured by SGL) made of carbon fibers were prepared, and these were placed on both sides of the membrane-electrode assembly to prepare a membrane-electrode gas diffusion layer assembly.

### Evaluation

For the membrane-electrode assembly and the membrane-electrode gas diffusion layer assembly, the following performances before and after the high potential durability test were evaluated, and the maintenance ratio of the performance after the durability test was evaluated before and after the durability test.

### High Potential Durability Test

It was carried out at 1.3V, 2 h hold, 80° C. and over-humidification (corresponding to 120% RH).

Real 1 cm² cell valuation

Cell evaluations were performed using respective membrane-electrode gas-diffusion-layer assemblies having 1 cm² electrode portions. Specifically, the current-voltage properties were evaluated under high humidification conditions (80% RH). The current-voltage properties were obtained in the sweep rate 20 mA/s, Anodicsweep. In addition, the current-voltage property was evaluated by a cell temperature of 80° C., a pressure of 150 kPa_ABS, a cathode gas species of Air, and a cathode gas flow rate of 2.0 L/min. Average thickness of the catalyst layer

Each membrane-electrode assembly was ion-milled or a cutter cut out the cross-section. Scanning electron-microscopy (SEM) was used to measure the thickness of the catalytic layers. At least 10 points were measured, and the average value was calculated.

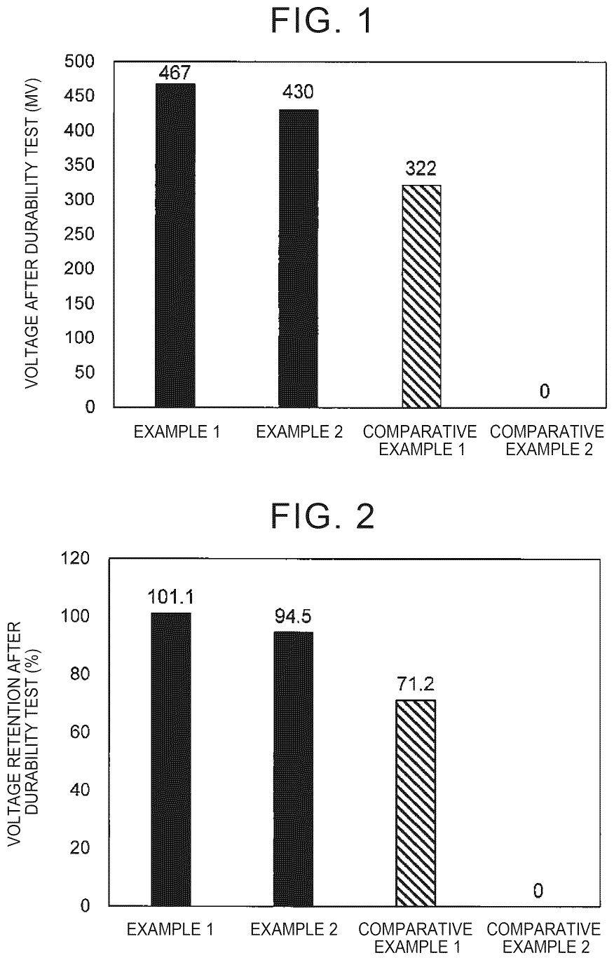

The properties and evaluation results of the modifiers used in Examples 1 and 2 and Comparative Examples 1 and 2 are shown in Table 1. FIG. 1 shows cell voltages after durability tests in 3.2 Acm⁻² for Examples 1 and 2 and Comparative Examples 1 and 2. FIG. 2 shows the voltage retention after the durability test in 3.2 Acm⁻² for Examples 1 and 2 and Comparative Examples 1 and 2.

TABLE 1

| | | | | | Comparative | Comparative |
|---|---|---|---|---|---|---|
| | | | Example 1 | Example 2 | Example 1 | Example 2 |
| Modifier | Type | | Melem | g-C₃N₄ | — | Melamine |
| | Water solubility | g/L | Less than 3 | Less than 3 | — | 3 or more |
| | Alcohol solubility | g/L | Less than 3 | Less than 3 | — | 3 or more |
| | Nitrogen equivalent | g/eq | 21.8 | 23.0 | — | 21.0 |
| | Weight percentage of nitrogen | Weight % | 64.2 | 60.9 | — | 66.6 |
| | Proportion of nitrogen atoms in | % | 45.5 | 57.1 | | 40 |
| | the total number of atoms | | | | | |
| | Total equivalent of pyridine type | g/eq | 31.1 | 23.0 | | 42.04 |
| | nitrogen and quaternary nitrogen | | | | | |
| Evaluation | Average thickness of the catalyst | μm | 6.1 | 5.7 | 6.5 | 6.2 |
| | layer before the endurance test | | | | | |
| | Average thickness of the catalyst | μm | 3.9 | 4.1 | 3.8 | 3.4 |
| | layer after the durability test | | | | | |
| | Thickness retention of the catalyst | % | 64 | 72 | 58 | 55 |
| | layer | | | | | |
| | Voltage retention after endurance | % | 101.1 | 94.5 | 71.2 | 0 |
| | test in 3.2 Acm⁻² | | | | | |

As shown in Table 1 and FIGS. 1 and 2, in Examples 1 and 2, the thickness retention ratio of the catalyst layer after the durability test was significantly improved and the oxidation resistance of the catalyst was improved as compared with Comparative Example 1 and Comparative Example 2. In Examples 1 and 2, a modifier having a total content of pyridine type nitrogen and quaternary nitrogen of 40 g/eq or less was used. In Comparative Example 1, no modifier was used. Comparative Example 2 is a melamine in which the modifier does not satisfy this content. Further, in Examples 1 and 2, as compared with Comparative Examples 1 and 2, the voltage and the voltage retention rate after the durability test at a high current density (3.2 Acm⁻²) were also significantly improved. cm What is claimed is:

1. An electrochemical oxygen reduction catalyst comprising:
metal particles; and a modifier that modifies the metal particles, wherein
the modifier is an organic nitrogen compound, and
the organic nitrogen compound contains pyridine type nitrogen and may further contain quaternary nitrogen, in which total content in the organic nitrogen compound of the pyridine type nitrogen and, when present, the quaternary nitrogen, is 40 g/eq or less.

2. The electrochemical oxygen reduction catalyst according to claim 1, wherein the modifier is a deammoniated condensate of melamine.

3. The electrochemical oxygen reduction catalyst according to claim 2, wherein the deammoniated condensate of melamine is at least one selected from a group consisting of melem, melam, melone, and g-C₃N₄.

4. The electrochemical oxygen reduction catalyst according to claim 1, wherein the metal particles are at least one selected from a group consisting of platinum particles, platinum alloy particles, and composite particles containing platinum.

5. The electrochemical oxygen reduction catalyst according to claim 1, wherein the metal particles are supported by a carrier, and the carrier is carbon.
